(19) United States
(12) Patent Application Publication
(10) Pub. No.: US 2009/0147959 A1
(43) Pub. Date: Jun. 11, 2009

(54) KEY STATUS DETECTING CIRCUIT

(76) Inventor: Hsing-Lu Chen, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/125,069

(22) Filed: May 22, 2008

(30) Foreign Application Priority Data
Dec. 6, 2007 (TW) 096146485

(51) Int. Cl. G06F 7/06

(52) U.S. Cl. 380/277

(57) ABSTRACT

The present invention provides a key status detecting circuit for detecting key statuses of a plurality of key modules, wherein the key modules respectively include a plurality of key units. The key status detecting circuit includes a plurality of first logic units, a plurality of first signal registering units, a plurality of second logic units, a second signal registering unit, and a control unit. The key status detecting circuit provided by the present invention does not have to connect each key to different pins of the control unit respectively and does not have to have the control unit regularly poll a data bus to detect which key is pressed, and thus the pin amount and loading of the control unit can be reduced, and efficiency of the control unit can be improved.

### BACKGROUND OF THE INVENTION

1. Field of the Invention

The present invention relates to a key status detecting circuit for detecting at least a key module, and more particularly, to a key status detecting circuit which can reduce the pin count and loading of a control unit and improve the efficiency of the control unit.

2. Description of the Prior Art

In general, there are two circuit schemes for detecting panel key modules in conventional electronic commercial devices (such as scanners, printers, copiers, or multi-function printers). The first of the circuit schemes is to respectively connect each key to a different pin of a control unit. However, this circuit scheme cannot satisfy design requirements having a large number of keys, since the control unit generally does not have sufficient pins.

The second of the circuit schemes is to have a control unit regularly poll a data bus to detect which key is pressed. When the control unit executes other programs, however, the control unit has to periodically interrupt the currently executing program to perform the polling operation. Thus, the loading on the control unit will be increased and efficiency of the control unit becomes lower.

### SUMMARY OF THE INVENTION

It is therefore one of the objectives of the present invention to provide a key status detecting circuit for detecting at least a key module, and the key status detecting circuit can reduce the pin count and loading of a control unit and improve the efficiency of the control unit, to solve the above problems.

According to an embodiment of the present invention, a key status detecting circuit is disclosed. The key status detecting circuit is coupled to a plurality of key modules respectively including at least a key unit. The key status detecting circuit includes a plurality of first logic units, a plurality of first signal registering units, a plurality of second logic units, a second signal registering unit, and a control unit. The first logic units are respectively coupled to the key modules, and each of the first logic units generates a first logic value according to a key output signal outputted by a corresponding key module received. The first signal registering units are respectively coupled to the key modules, and are for registering the key output signal outputted by the corresponding key module. The second logic units are respectively coupled to the key modules, and each of the second logic units generates a second logic value according to the key output signal outputted by the corresponding key module received. The second signal registering unit is coupled to the first signal registering units. The control unit is coupled to the first logic units, the second logic units, and the second signal registering unit. When the control unit receives a specific first logic value from a specific first logic unit corresponding to a specific key module, the control unit generates a control signal according to a specific second logic value outputted by a specific second logic unit corresponding to the specific key module to control the second signal registering unit to read a specific key output signal outputted by the specific key module from a specific first signal registering unit corresponding to the specific key module and register the specific key output signal, and the control unit receives the specific key output signal from the second signal registering unit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a simplified block diagram of a key status detecting circuit in accordance with an embodiment of the present invention.

### DETAILED DESCRIPTION

Certain terms are used throughout the following description and the claims to refer to particular system components. As one skilled in the art will appreciate, manufacturers may refer to a component by different names. This document does not intend to distinguish between components that differ in name but not function. In the following discussion and in the claims, the terms “include”, “including”, “comprise”, and “comprising” are used in an open-ended fashion, and thus should be interpreted to mean “including, but not limited to . . . ” The terms “couple” and “coupled” are intended to mean either an indirect or a direct electrical connection. Thus, if a first device couples to a second device, that connection may be through a direct electrical connection, or through an indirect electrical connection via other devices and connections.

The present invention relates to a key status detecting circuit that can be implemented in an electronic commercial device having a plurality of panel key modules. This document will illustrate several exemplary embodiments that apply the key status detecting circuit in the present invention. However, a person of average skill in the pertinent art should be able to understand that the present invention can be applied to various similar types of electronic commercial devices and is not limited to the particular embodiments described in the following paragraphs or to the particular manner in which any features of such embodiments are implemented.

In general, the key status detecting circuit of the present invention can be applied to all kinds of electronic commercial device. By way of example (but not limitation), a key status detecting circuit applied to an electronic commercial device having a plurality of panel key modules (such as a scanner, a printer, a copier, a fax, or a multi-function printer) is disclosed in accordance with the present invention. In addition, under a condition of not affecting the technical disclosure of the present invention, an electronic commercial device having three panel key modules will be used as an example to illustrate the key status detecting circuit in the present invention.

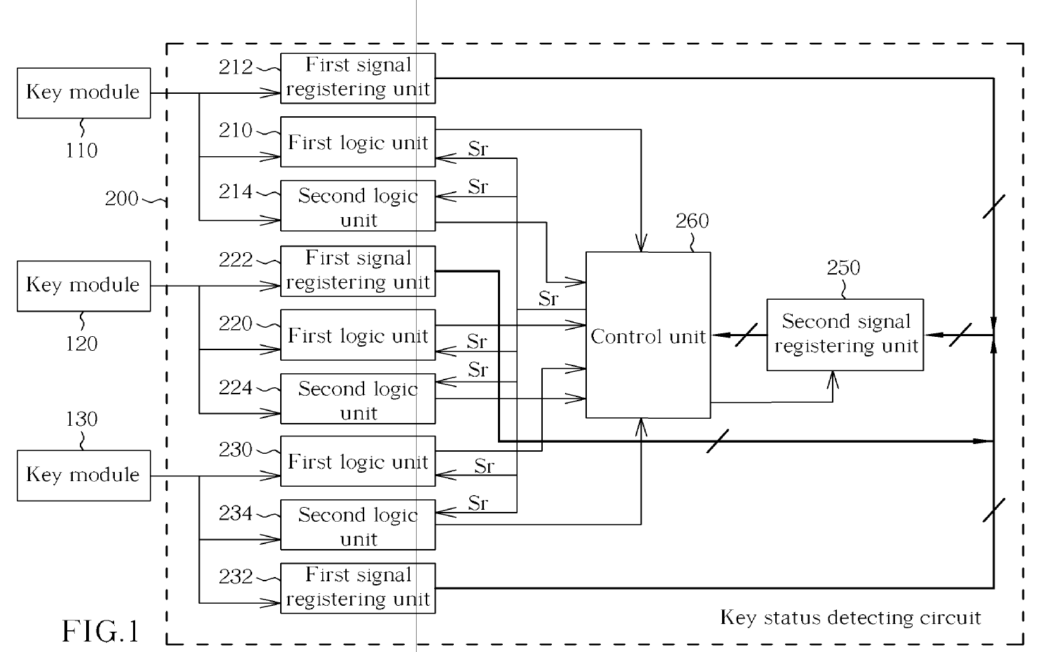

Please refer to FIG. 1. FIG. 1 shows a simplified block diagram of a key status detecting circuit 200 in accordance with an embodiment of the present invention. The key status detecting circuit 200 is utilized for detecting statuses of key modules 110, 120, 130, and the key modules 110, 120, 130 include a plurality of key units (not shown), respectively. As shown in FIG. 1, the key status detecting circuit 200 includes three first logic units 210, 220, 230, three first signal registering units 212, 222, 232, three second logic units 214, 224, 234, a second signal registering unit 250, and a control unit 260. The first logic units 210, 220, 230 are respectively coupled to the key modules 110, 120, 130, and the first logic unit 210 generates a first logic value (such as 0 or 1) according to whether a key output signal (not shown) outputted by the key units of the key module 110 is received. The first logic unit 220 generates the first logic value (such as 0 or 1) according to whether a key output signal (not shown) outputted by the key units of the key module 120 is received. The first logic unit 230 generates the first logic value (such as 0 or 1) according to whether receiving a key output signal (not shown) outputted by the key units of the key module 130. The first signal registering units 212, 222, 232 are respectively coupled to the key modules 110, 120, 130, and the first signal registering unit 212 is utilized for registering the key output signal (not shown) outputted by the key units of the key module 110. The first signal registering unit 222 is utilized for registering the key output signal (not shown) outputted by the key units of the key module 120. The first signal registering unit 232 is utilized for registering the key output signal (not shown) outputted by the key units of the key module 130. The second logic units 214, 224, 234 are respectively coupled to the key modules 110, 120, 130, and the control unit 260. The second logic unit 214 generates a second logic value (such as 0 or 1) according to whether the key output signal outputted by the key module 110 is received. The second logic unit 224 generates the second logic value (such as 0 or 1) according to whether receiving the key output signal outputted by the key module 120 is received. The second logic unit 234 generates the second logic value (such as 0 or 1) according to whether the key output signal outputted by the key module 130 is received. The second signal registering unit 250 is coupled to the first signal registering units 212, 222, 232, and the control unit 260. The control unit 260 is coupled to the first logic units 210, 220, 230, the second logic units 214, 224, 234, and the second signal registering unit 250. When the control unit 260 receives a specific first logic value from a specific first logic unit corresponding to a specific key module (the key module 110, 120, or 130), the control unit 260 generates a control signal (not shown) according to a specific second logic value (such as 0 or 1) outputted by a specific second logic unit (the second logic unit 214, 224, or 234) corresponding to the specific key module to control the second signal registering unit 250 to read a specific key output signal (not shown) outputted by the specific key module from a specific first signal registering unit (the first signal registering unit 212, 222, or 232) corresponding to the specific key module and register the specific key output signal, and then receives the specific key output signal from the second signal registering unit 250. In addition, after the control unit 260 receives the specific second logic value outputted by the specific second logic unit corresponding to the specific key module and the specific first logic value outputted by the specific first logic unit corresponding to the specific key module, the control unit 260 further outputs a reset signal Sr to the specific second logic unit corresponding to the specific key module and the specific first logic unit corresponding to the specific key module. Please note that the above embodiment is only for illustrative purposes and is not meant to be a limitation of the present invention. For example, the number of key modules that the key status detecting circuit in the present invention can detect is not limited to three in the above embodiment. The key status detecting circuit 200 can detect any number of key modules by adjusting the number of the first logic units, the first signal registering units, and the second logic units. Next, this document illustrates details of the operational scheme of the key status detecting circuit 200 in the present invention.

For example, when a key unit (not shown) of the key module 110 is pressed, the key unit will generate a key output signal (not shown), and the key output signal will be registered in the first signal registering unit 212. When the first logic unit 210 receives the key output signal generated by the key unit of the key module 110, the first logic unit 210 will generate a first logic value (such as a logic 1) to notify the control unit 260 that there is a key unit being pressed. When the second logic unit 214 receives the key output signal generated by the key unit of the key module 110, the second logic unit 214 will generate a second logic value (such as a logic 1) to notify the control unit 260 that the pressed key unit is in the key module 110. Thus, the control unit 260 will generate a control signal (not shown) to control the second signal registering unit 250 to read the key output signal outputted by the specific key module from the first signal registering unit 212 and register the key output signal, and then receive the key output signal from the second signal registering unit 250. In addition, after the control unit 260 receives the second logic value outputted by the second logic unit 214 and the first logic value outputted by the first logic unit 210, the control unit 260 further outputs a reset signal Sr to the second logic unit 214 and the first logic unit 210.

Briefly summarized, the key status detecting circuit disclosed by the present invention does not have to connect each key to different pins of the control unit respectively and does not have to have the control unit regularly poll a data bus to detect which key is pressed, and thus the pin amount and loading of the control unit can be reduced, and efficiency of the control unit can be improved.

Those skilled in the art will readily observe that numerous modifications and alterations of the device and method may be made while retaining the teachings of the invention.

What is claimed is:

1. A key status detecting circuit, coupled to a plurality of key modules respectively including at least a key unit, the key status detecting circuit comprising:
a plurality of first logic units, respectively coupled to the key modules, each of the first logic units generating a first logic value according to a key output signal outputted by a corresponding key module received;
a plurality of first signal registering units, respectively coupled to the key modules, for registering the key output signal outputted by a corresponding key module;
a plurality of second logic units, respectively coupled to the key modules, each of the second logic units generating a second logic value according to the key output signal outputted by the corresponding key module received;
a second signal registering unit, coupled to the first signal registering units; and
a control unit, coupled to the first logic units, the second logic units, and the second signal registering unit, and when the control unit receives a specific first logic value from a specific first logic unit corresponding to a specific key module, the control unit generates a control signal according to a specific second logic value outputted by a specific second logic unit corresponding to the specific key module to control the second signal registering unit to read a specific key output signal, outputted by the specific key module, from a specific first signal registering unit corresponding to the specific key module and register the specific key output signal, and the control unit receives the specific key output signal from the second signal registering unit.

2. The key status detecting circuit of claim 1, wherein each key module comprises a plurality of key units.

3. The key status detecting circuit of claim 1, wherein after the control unit receives the specific second logic value outputted by the specific second logic unit corresponding to the specific key module, the control unit further outputs a reset signal to the specific second logic unit corresponding to the specific key module.

4. The key status detecting circuit of claim 1, wherein after the control unit receives the specific first logic value outputted by the specific first logic unit corresponding to the specific key module, the control unit further outputs a reset signal to the specific first logic unit corresponding to the specific key module.

5. The key status detecting circuit of claim 1, wherein the key modules are used in one of a scanner, a printer, a copier, a fax, and a multi-function printer.
